(19) United States
(12) Patent Application Publication
(10) Pub. No.: US 2007/0199320 A1
(43) Pub. Date: Aug. 30, 2007

(54) Flexible engine cooling and exhaust gas temperature controls for diesel after-treatment regeneration and engine performance improvement

(76) Inventors: James H. Yager, St. Charles, IL (US); Shengmei Zhang, Schaumburg, IL (US); Qianfan Xin, Lake Zurich, IL (US); Gregory R. Lapp, Fort Wayne, IN (US); Jacob Thomas, Algonquin, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 11/364,526

(22) Filed: Feb. 28, 2006

(51) Int. Cl. F02B 29/04; F02D 23/00; F02B 33/44

(52) U.S. Cl. 60/599; 60/600; 60/605.1; 60/605.2

(57) ABSTRACT

System, methods, and strategies for regulating charge air temperature in an intake manifold of an internal combustion engine (50) by controlling the flow rate and temperature of liquid engine coolant flowing through a liquid flow path of a charge air cooler (72) that is in heat exchange relationship with charge air entering the intake manifold over a range that provides for the charge air to be selectively heated and cooled by liquid engine coolant. The invention provides flexible control that is useful in controlling exhaust gas temperature for regeneration and/or efficiency restoration of exhaust after-treatment devices (66) as well as improved engine performance.

### FIELD OF THE INVENTION

The present invention relates to internal combustion engines, especially to diesel engine systems, methods, and strategies for improving engine performance at different ambient conditions and improving exhaust after-treatment performance, the latter including improving regeneration of diesel particulate filters (DPF's), improving regeneration of NOₓ adsorbers, and improving NOₓ conversion efficiency by selective catalytic reduction (SCR). For accomplishing these improvements the inventive systems, methods, and strategies comprise controlling the operation of a cooling system that regulates temperature in an engine intake manifold and temperature in an engine exhaust manifold through such regulation.

### BACKGROUND OF THE INVENTION

The diesel engine industry is facing ever more stringent legislative requirements to reduce oxides of nitrogen (NOₓ) and particulate matter (PM) emissions. After-treatment devices such as DPF's and NOₓ adsorbers and processes such as SCR are attractive solutions for reducing PM and NOₓ emissions.

Improvements in DPF technology have enabled the particulate trapping efficiency of a DPF to be increased and pressure loss to be reduced. However, after a certain amount of soot has been trapped, even an improved DPF must be regenerated in order to restore performance.

Regeneration of a DPF can be initiated in various ways by various devices and methods. Basically, DPF regeneration is initiated by raising exhaust gas temperature to one that is high enough to initiate and sustain combustion of the trapped soot. The burning of trapped PM reduces exhaust back-pressure (EBP) and recovers DPF trapping efficiency. This process of soot oxidation is commonly termed DPF regeneration.

Known techniques for facilitating or forcing DPF regeneration include: 1) developing efficient fuel additives to lower the light-off temperature for DPF regeneration; 2) using post-injection of diesel fuel upstream of the DPF to increase exhaust gas temperature; and 3) using an auxiliary heating source (such as a burner or electric heater) to increase exhaust gas temperature.

Disadvantages of these known techniques include additional hardware cost (e.g., adding post-injection device), reliability, and warranty cost. Innovative systems and strategies for better exhaust temperature control are therefore desirable for more effective and efficient DPF regeneration.

For NOₓ after-treatment, exhaust temperatures must similarly be elevated 1) to achieve high conversion efficiency for devices performing SCR and 2) to regenerate and/or de-sulfate devices such as NOₓ adsorbers. Consequently, thermal management of diesel engine exhaust assumes increased importance in achieving compliance with applicable tailpipe emission requirements.

Engine exhaust temperature is affected by factors that include intake manifold temperature, which is itself affected directly by the temperature of charge air exiting a charge air cooler (CAC) in the engine intake system, EGR gas temperature, EGR rate, air/fuel (A/F) ratio, in-cylinder fuel injection timing, and quantity of fueling (or brake specific fuel consumption, which is affected by engine pumping loss and indicated power).

### SUMMARY OF THE INVENTION

Generally speaking, the present invention relates to improvements in systems, methods, and strategies for initiating and sustaining regeneration of certain exhaust after-treatment devices, such as DPF's and NOₓ adsorbers, and for achieving high conversion efficiencies in other after-treatment devices, such as those that perform SCR, these improvements following from the inventors' recognition of the importance that flexible control of charge air temperature can have in such systems, methods, and strategies.

Flexible control is accomplished by a flow control system that controls the flow of engine coolant through a charge air cooler (CAC) in a way that allows charge air temperature to be increased to levels for performing regeneration of certain after-treatment devices and for achieving high conversion efficiencies of other after-treatment devices. In conjunction with a strategy for controlling an EBP valve and/or an intake throttle (IT) valve, a flexible CAC control strategy can elevate exhaust gas temperature to temperatures suitable for accomplishing those tasks. The use of additional NOₓ emission control strategies involving regulating EGR rate and fuel injection timing may also be coordinated with use of flexible CAC control, EBP control, and IT control. The invention can enable an engine manufacturer to meet applicable requirements for both tailpipe emission compliance and after-treatment device (e.g. DPF) regeneration without the use of either a post-injection system upstream of a DPF or of an auxiliary heating source.

Flexible control of charge air temperature is an important tool for elevating exhaust gas temperature to temperatures suitable for regenerating certain after-treatment devices and achieving high conversion efficiencies in other devices at virtually all applicable engine speeds, engine loads, and ambient conditions for turbocharged diesel engines.

Exhaust gas generated by a diesel engine running at low load and/or at cold ambient temperature is generally not hot enough to initiate and sustain combustion of soot trapped in a DPF. In order to raise exhaust gas temperature to one suitable for DPF regeneration under extreme conditions like those just mentioned, flexible control of charge air temperature by control of both the rate and the temperature of coolant flow through a coolant-cooled charge air cooler (CAC) can be an important part of an overall control strategy for producing the large elevation of exhaust gas temperature for successful combustion under such conditions.

Other auxiliary means for aiding the overall strategy can of course also be employed, when appropriate, to achieve exhaust gas temperatures for burning trapped soot in a DPF and simultaneously reducing in-cylinder oxygen concentration (or air-to-fuel ratio) to control NOₓ content in engine exhaust gas. Such other means include for example: selectively operating an EBP valve and/or IT at different speeds and loads to selectively restrict charge air and exhaust gas flows; regulating EGR rate and temperature; and retarding fuel injection timing.

The invention presents seven presently preferred embodiments of flow control systems for accomplishing flexible control of charge air temperature for regenerating certain exhaust after-treatment devices and for achieving high conversion efficiency in other after-treatment devices by control of engine coolant flow through a CAC.

Also presented are CAC and EBP control strategies for attaining compliance with both applicable tailpipe emissions requirements and after-treatment regeneration requirements.

Significant advantages of the present invention for after-treatment device regeneration include: elimination of the need for any post-injection system upstream of the after-treatment device or any auxiliary heating source to assist regeneration, and consequently avoidance of the added installation and warranty costs of including such a device or source in an engine; a minimal amount of additional hardware for a base engine model (i.e., the addition of only one or two control valves on the assumption that an EBP valve and an IT valve are pre-existing parts of the base engine).

Through flexible control of CAC coolant flow rate and coolant temperature, the present invention also provides cost-effective solutions for improved engine performance and tailpipe emission control. Apart from its use in DPF regeneration, flexible control can provide quicker and better engine warm-up characteristics; can eliminate a need for an “idle kicker” for vehicle cab heating; can provide best-in-class hydrocarbon and white smoke clean-up; can improve engine transient response; can offer better and quicker emissions compliance during engine start-up, transient and cold climate operation; can improve vehicle fuel economy during steady-state, transient and engine warm-up; can improve fuel economy in cold climates; can reduce fuel injection timing advance and peak cylinder pressure at cold ambient operation for better engine cylinder head reliability; can reduce engine accessory power through replacing cooling fan power by CAC coolant pump power, especially at hot ambient; and can reduce exhaust manifold temperature at high altitude or hot ambient full load for better engine manifold and/or turbine durability by increasing coolant flow in CAC to reduce intake and exhaust manifold temperatures.

One generic aspect of the present invention relates to an internal combustion engine comprising an intake system for creating charge air in an intake manifold, combustion chambers in which charge air from the intake manifold and fuel are combusted, and an exhaust system for conveying exhaust gas from the combustion chambers through an exhaust gas treatment device that at times requires regeneration by elevation of exhaust gas temperature.

A charge air cooler comprises an airflow path for charge air upstream of the intake manifold and a liquid flow path for liquid engine coolant in heat exchange relationship with the airflow path. A flow control system controls engine coolant flow through the liquid flow path of the charge air cooler.

A control system comprises an executable strategy for conjunctive control of the flow control system and of the exhaust system to initiate regeneration of the exhaust gas treatment device.

Another generic aspect of the invention relates to an internal combustion engine comprising an intake system for creating charge air in an intake manifold and combustion chambers in which charge air from the intake manifold and fuel are combusted. A charge air cooler comprises a liquid flow path for liquid engine coolant to flow in heat exchange relationship with the charge air flow through the charge air cooler. An engine coolant temperature and flow control system controls temperature and flow of engine coolant through the charge air cooler for selectively heating and cooling the charge air flowing through the charge air cooler.

Still another generic aspect of the invention relates to a method for controlling temperature of exhaust gas flow through an exhaust system of an internal combustion engine comprising an intake system for creating charge air and delivering the charge air to engine combustion chambers. A charge air cooler is disposed in heat exchange relation with the charge air and comprises a liquid flow path for liquid engine coolant to flow through the charge air cooler. A control system controls the exhaust system and engine coolant flow through the charge air cooler.

The method comprises operating the control system to conjunctively control the exhaust system and coolant flow through the liquid flow path of the charge air cooler.

Still another generic aspect of the invention relates to a method for regulating charge air temperature in an intake manifold of an internal combustion engine comprising controlling the temperature of liquid engine coolant flowing through a liquid flow path of a charge air cooler that is in heat exchange relationship with charge air entering the intake manifold over a range that provides for the charge air to be selectively heated and cooled by liquid engine coolant.

The foregoing, along with further features and advantages of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1A is a schematic diagram illustrating a first of the seven embodiments referred to earlier.

FIG. 1B is a schematic diagram illustrating a second of the seven embodiments referred to earlier.

FIG. 1C is a schematic diagram illustrating a third of the seven embodiments referred to earlier.

FIG. 1D is a schematic diagram illustrating a fourth of the seven embodiments referred to earlier.

FIG. 2 is a schematic diagram illustrating a fifth of the seven embodiments.

FIG. 3 is a schematic diagram illustrating a sixth of the seven embodiments.

FIG. 4 is a schematic diagram illustrating a seventh of the seven embodiments.

FIGS. 5A-H are graph plottings of certain relationships between flexibly controlled coolant flow rate, exhaust gas temperature (measured at turbine outlet), and CAC outlet temperature at normal ambient and cold ambient temperatures for several different engine loads at several different engine speeds.

FIG. 6 is a graph illustrating the effect of air-to-fuel ratio on NOₓ and PM emissions.

FIG. 7A is a graph plotting of certain relationships between exhaust back-pressure valve operation and turbine outlet exhaust restriction for various operating conditions.

FIG. 7B is a graph plotting of certain relationships between exhaust back-pressure valve operation and exhaust manifold back pressure for various operating conditions.

FIG. 7C is a graph plotting of certain relationships between exhaust back-pressure valve operation and turbine outlet exhaust gas temperature for various operating conditions.

FIG. 7D is a graph plotting of certain relationships between exhaust back-pressure valve operation and brake specific fuel consumption (BSFC) for various operating conditions.

FIG. 7E is a graph plotting of certain relationships between exhaust back-pressure valve operation and air/fuel (A/F) ratio for various operating conditions.

FIG. 7F is a graph plotting of certain relationships between exhaust back-pressure valve operation and EGR rate percent for various operating conditions.

FIGS. 8 and 9 are respective graphs illustrating the CAC cooling control strategy to meet both emission standards and diesel after-treatment performance and/or regeneration requirements at different ambient conditions, engine speeds and loads.

FIGS. 10A, 10B, 10C, 10D, 10E, and 10F are respective graphs illustrating various CAC cooling and exhaust gas temperature control strategies for regenerating certain exhaust after-treatment devices and for achieving high conversion efficiency in other after-treatment devices.

### DETAILED DESCRIPTION OF THE PREFERRED EMBODIMENT

A flexibly controlled liquid-cooled charge air cooler (CAC) in a turbocharged diesel engine can be flexibly controlled to aid in attaining exhaust gas temperatures suitable for regenerating and/or achieving high conversion efficiency of after-treatment devices, depending on the particular after-treatment device, over an entire engine speed-load domain at different ambient temperatures. An overall strategy for attaining those exhaust gas temperatures preferably comprises flexible control of a CAC in conjunction with control of exhaust back-pressure (EBP) by controlling the extent to which an EBP valve is allowed to restrict exhaust gas flow. The overall strategy can accomplish DPF regeneration at the same time that engine air/fuel (A/F) ratio is reduced for NOₓ emission compliance. An intake throttle, as an optional device, can also be used for NOₓ emission control.

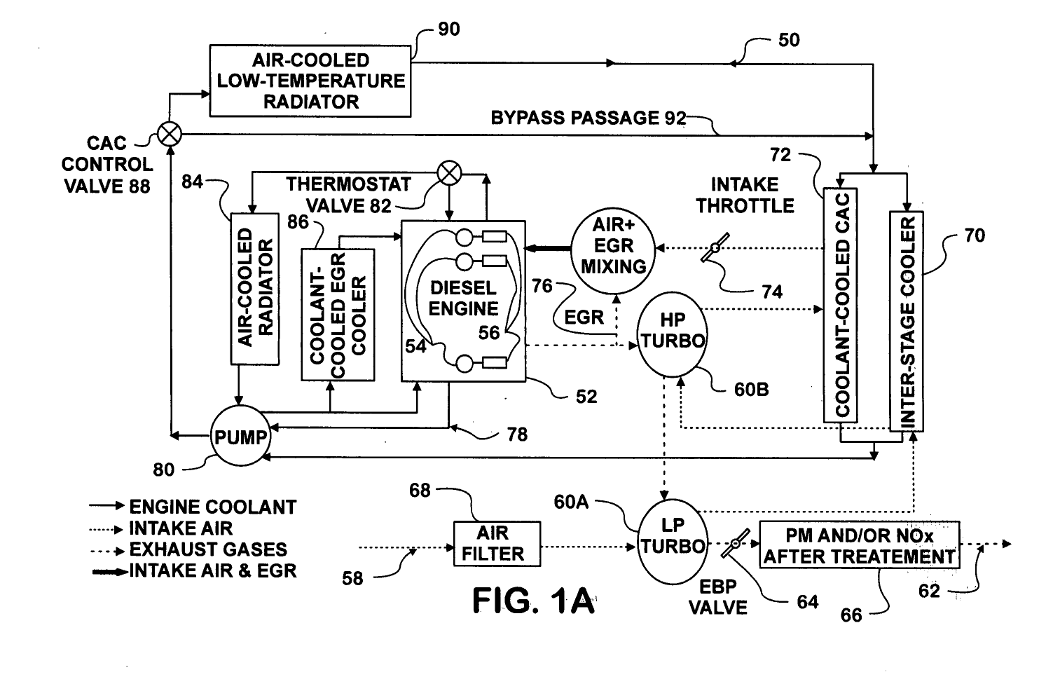

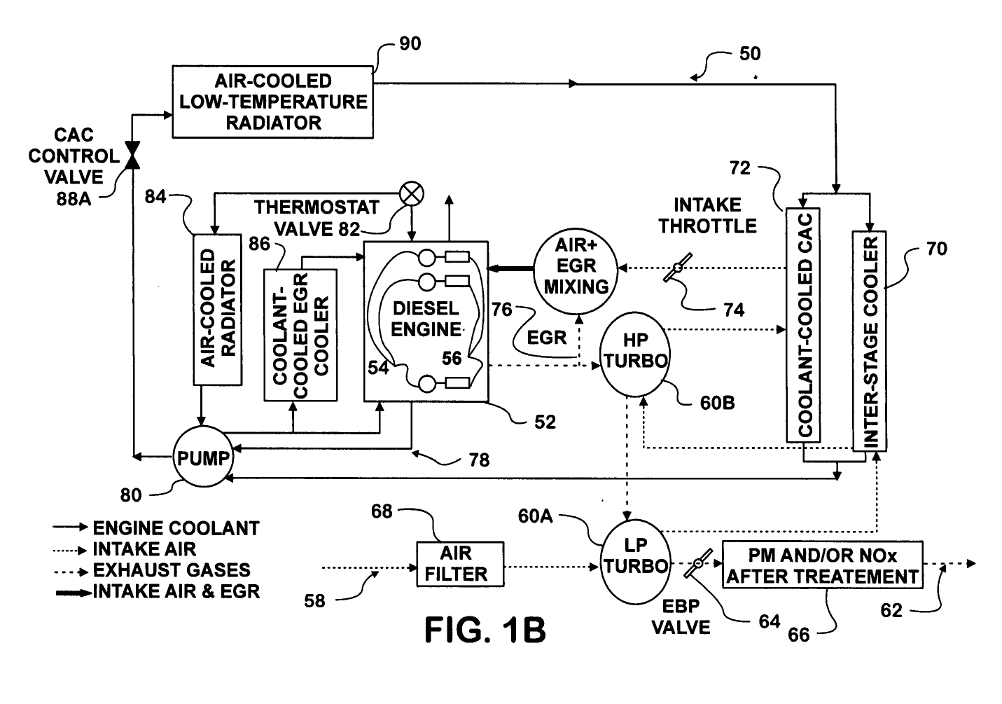

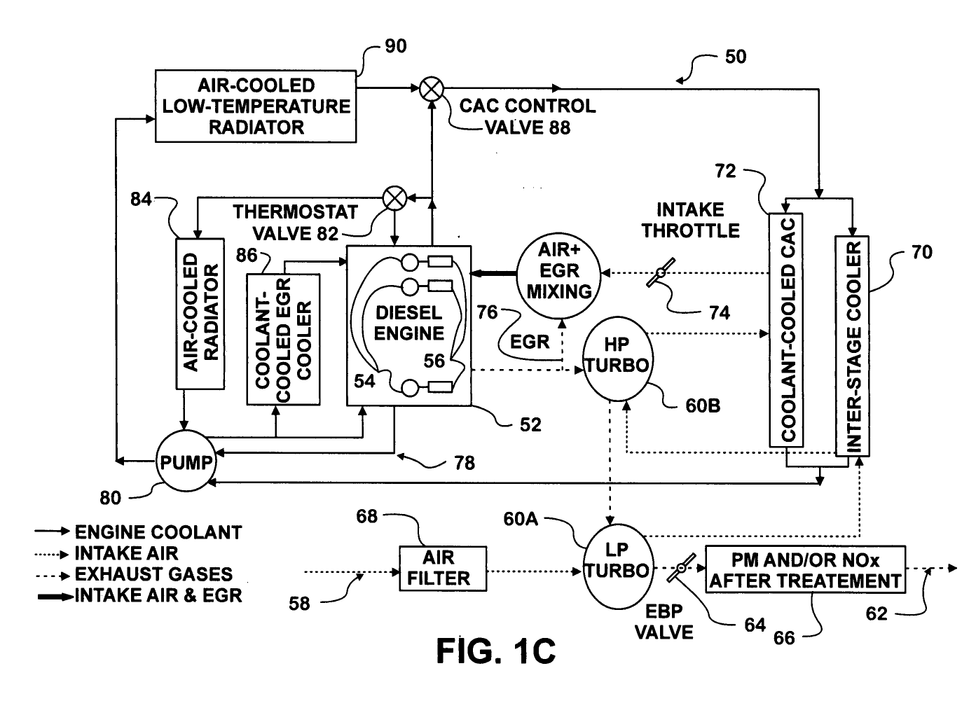

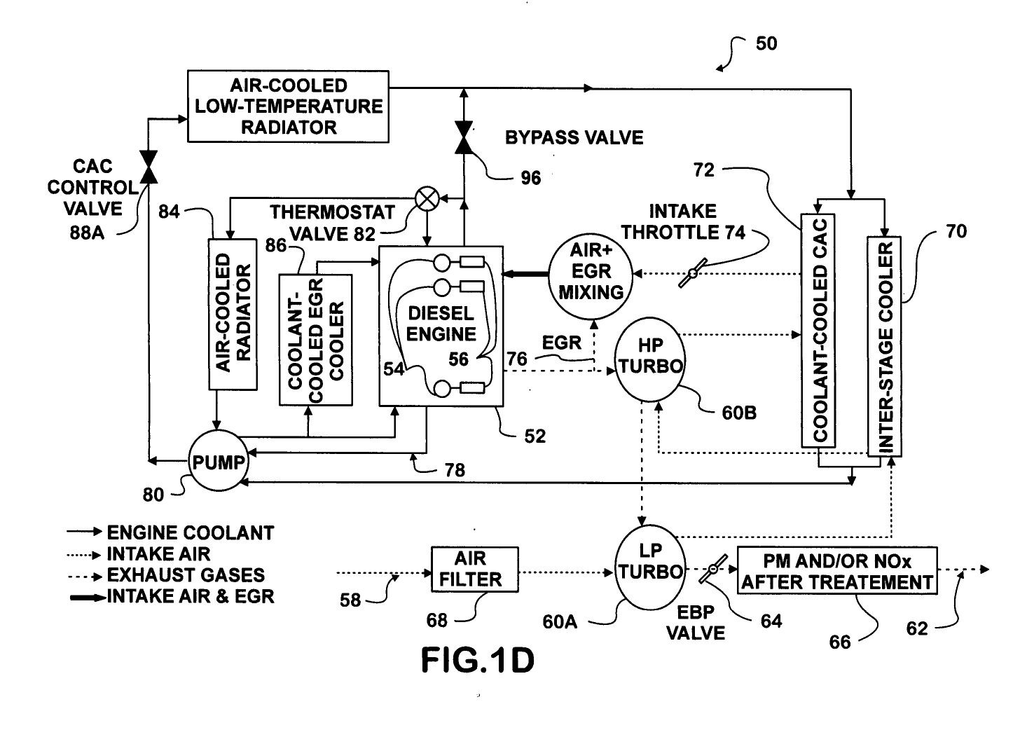

FIGS. 1A-4 show seven embodiments of flexible control systems, differing in CAC coolant feed location, numbers and type of valves, and number of coolant pumps. The flow directions for the various working fluids designated by the accompanying legend in each FIGURE are indicated by the directional arrows. It is to be understood that principles of the invention are potentially applicable to any exhaust after-treatment device whose operation and performance depends on the ability to manage exhaust temperature.

FIG. 1A shows a diesel engine 50 comprising an engine block 52 containing engine cylinders 54 into which fuel injectors 56 of a fuel injection system directly inject diesel fuel. An intake system 58 delivers charge air created by compressors of stages 60A, 60B of a two-stage turbocharger, with or without an inter-stage cooler, to cylinders 54 where the charge air is compressed to temperatures that cause the injected fuel to ignite and power the engine. An exhaust system 62 conveys exhaust gas from cylinders 54 through turbines of stages 60A, 60B to operate the turbocharger. Although a two-stage turbocharger is shown here, principles of the invention can be applied to essentially any engine turbocharger.

Exhaust system 62 comprises an EBP valve 64 and an after-treatment device which is shown in the drawing as particulate matter (PM) and/or NOₓ after-treatment device 66 (e.g., a diesel particulate filter (DPF), NOₓ adsorber, SCR), through which exhaust gas successively flows after leaving the turbocharger. At times a particular after-treatment device 66 may require regeneration, such as to burn off trapped soot when the after-treatment device is a DPF.

Intake system 58 comprises an air filter 68 that filters air entering the intake system before it reaches the turbocharger. After the turbocharger has boosted the pressure of the filtered intake air to create charge air, the charge air is cooled. In the illustrated embodiment cooling is performed by an inter-stage cooler 70 between the two turbocharger compressor stages and a liquid-cooled charge air cooler (CAC) 72. The coolers 70, 72 are essentially liquid-to-air heat exchangers. Cooler 70 cools the air passing from the low-pressure stage 60A to the high-pressure stage 60B. CAC 72 cools the charge air leaving stage 60B. Intake system 58 further comprises an intake throttle (IT) valve 74 after CAC 72, although the most general principles of the invention do not require the presence of an intake throttle.

Recirculation of exhaust gas for entrainment with charge air entering an intake manifold of engine 50 is controlled by an EGR system 76 that typically includes an EGR valve.

Engine 50 is liquid-cooled and therefore comprises a cooling system 78 that includes a pump 80, one that is typically engine-driven. A portion of cooling system 78 is conventional in that it comprises a thermostat valve 82 that at cold-starting is closed, but opens when the engine has warmed-up to operating temperature. When closed, valve 82 prevents coolant from being pumped out of block 52 to a main radiator 84 and back to the block. Once open, valve 82 allows coolant to be pumped out of block 52 to radiator 84 and back to the block. When EGR system 76 requires cooling of exhaust gas being recirculated, coolant is pumped through an EGR cooler 86.

Cooling system 78 further comprises a CAC control valve 88 and an air-cooled low-temperature radiator 90. Valve 88 has an inlet that is in fluid communication with an outlet of main radiator 84. The communication is not direct, but rather takes places through pump 80. Valve 88 also has a first outlet in fluid communication through a by-pass passage 92 with the inlets of coolers 70, 72. Valve 88 also has a second outlet in fluid communication the inlets of coolers 70, 72 through radiator 90. The two passages from the outlets of valve 88 to the coolers provide two parallel flow paths from the valve to the coolers.

Valve 88 is a three-way valve that is selectively operable to a first condition that disallows flow through one of the two parallel flow paths while allowing flow through the other, to a second condition that disallows flow through the other flow path while allowing flow through the one flow path, a third condition that divides flow between the two, and a fourth condition that allows no flow through either.

When valve 88 is not blocking inlet flow, coolant can flow from the outlet of engine-driven coolant pump 80 through valve 88 to pass 1) either entirely through radiator 90, 2) entirely through by-pass passage 92, or 3) divide between the two parallel flow paths before passing through coolers 70, 72. In this way, valve 88 enables temperature of coolant flow to the coolers 70, 72 to be controlled by controlling what percentage of the incoming flow is cooled by passage through radiator 90. By-pass passage 92 provides “hotter” coolant to coolers 70, 72 directly from pump 80. Return coolant flows from coolers 70, 72 to the inlet of pump 80.

By-pass passage 92 may be optional in certain engines. When the by-pass passage is not present, valve 88 can be replaced by a simpler on-off valve either upstream or downstream of the CAC heat exchangers 70, 72. Such an embodiment is shown in FIG. 1B.

FIG. 1B shows an engine 50 having the same components arranged in the same way as engine 50 of FIG. 1A and identified by the same reference numerals, but lacking by-pass passage 92 and having on an on-off control valve 88A instead of the three-way valve 88 shown in FIG. 1A. Control valve 88A may be of any suitable construction and may be one that is either fully open or fully closed, or one that can selectively restrict flow. While valve 88A is shown upstream of radiator 90, it could alternatively be downstream of radiator 90. In either case, valve 88A controls flow through radiator 90.

FIG. 1C shows an engine 50 having the same components arranged in the same way as engine 50 of FIG. 1A and identified by the same reference numerals, but with three-way valve 88 arranged differently from FIG. 1A. In FIG. 1C, the coolant flow to inter-stage cooler 70 and CAC 72 is controlled by valve 88 to 1) come entirely directly from engine block 52, 2) come entirely from pump 80 after having been cooled by radiator 90, or 3) comprise flows from both engine block 52 and radiator 90 as apportioned by valve 88. Valve 88 can also be operated to shut off all flow to inter-stage cooler 70 and CAC 72. Because of the direct connection of valve 88 to the engine block, it becomes possible for somewhat “hotter” coolant flow to be delivered to inter-stage cooler 70 and CAC 72 when valve 88 is operated to allow flow directly from the engine block.

FIG. 1D shows an engine 50 having the same components as in FIG. 1C and identified by the same reference numerals, with the exception that two on-off valves 88A and 96 are connected as shown in replacement of three-way valve 88. The cooling arrangement of FIG. 1D may however be considered the functional equivalent of that of FIG. 1C. Coordination of the operation of valves 88A and 96 allows flow to inter-stage cooler 70 and CAC 72 1) to come entirely directly from engine block 52 when valve 96 is open and valve 88A is closed, 2) to come entirely from pump 80 with cooling provided by radiator 90 when valve 88A is open and valve 96 is closed, 3) to be apportioned between flow from engine block 52 and flow from radiator 90 when both valves 88A and 96 are open, and 4) to be shut off when both valves 88A and 96 are closed. Each valve may be either an on-off valve or one that can selectively restrict flow.

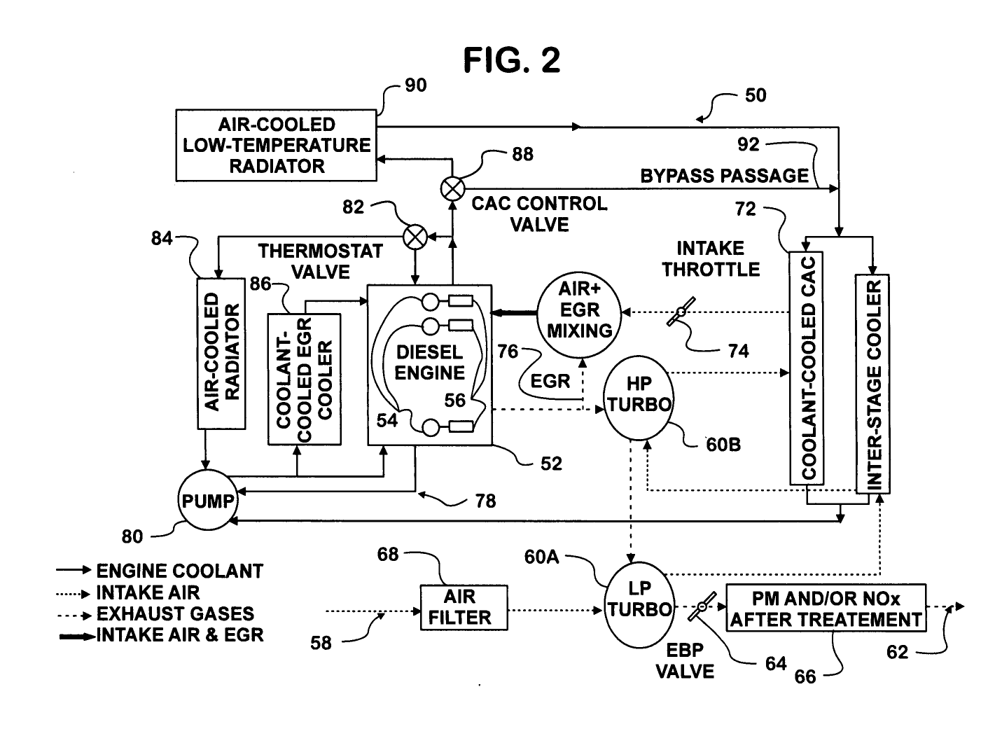

The embodiment of FIG. 2, like those of FIGS. 1C and 1D can provide somewhat “hotter” coolant flow for heating charge air because the coolant to the inlet of valve 88 is drawn directly from the engine outlet (i.e., near thermostat inlet), instead of from pump 80. The same reference numerals previously used are used to designate the same components in FIG. 2. Valve 88 in FIG. 2 operates in the same way as described in connection with FIG. 1A.

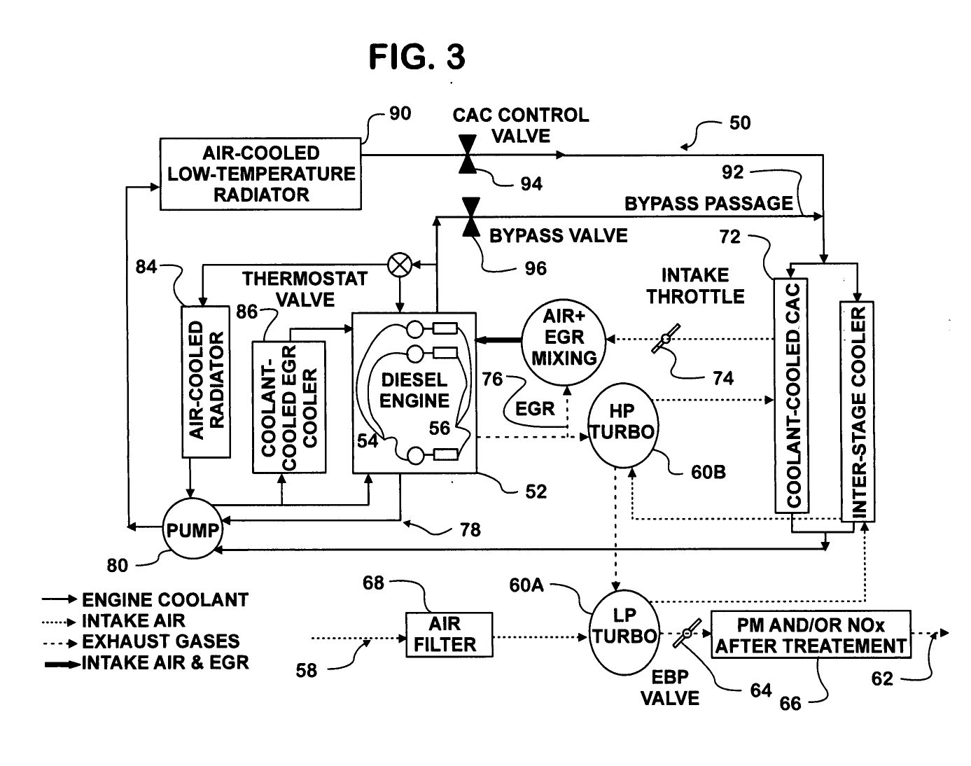

The embodiment of FIG. 3 can provide the flexibility of “colder” coolant flow in some instances and “hotter” coolant flow in others. The same reference numerals previously used are used to designate the same components in FIG. 3. Instead of a three-way valve like valve 88 of FIGS. 1A and 2, the embodiment of FIG. 3 communicates the outlet of pump 80 directly with the inlet of radiator 90 and communicates the radiator outlet to heat exchangers 70, 72 through a control valve 94. A parallel flow path leading to coolers 70, 72 provides for coolant to be drawn directly from the engine outlet (i.e., near thermostat inlet) and the flow controlled by a second valve 96.

The “cooler” coolant flow rate is controlled by valve 94 while the “hotter” coolant flow rate is controlled by valve 96. Coolest flow through coolers 70, 72 occurs when valve 94 is fully open and valve 96 fully closed. Hottest flow occurs when valve 96 is fully open and valve 94 is fully closed. Concurrent opening of the two valves mixes the two flows to provide other temperatures for coolant flow through the two coolers.

The words “cooler” and “hotter” are understood in context as relative descriptors, meaning simply that the “cooler” coolant has a lower temperature than the “hotter” coolant.

The noun “cooler” in the phrase “charge air cooler” should also be understood in context. When the charge air cooler cools the air, it is performing a cooling function, but when it heats the air, it is performing a heating function. Hence, while the charge air cooler is referred to as a “cooler”, it is actually a heat exchanger that can either heat or cool the air. Consequently, the charge air cooler shown and described here should not be construed as performing only a cooling function, and it will continue to be referred to as a charge air cooler throughout this document even though at times it may perform heating.

Each valve 94, 96 can be an on-off valve or a continuously regulated one. The return flow returns to the inlet of the coolant pump. Valve 94 can be placed either upstream or downstream of coolers 70, 72.

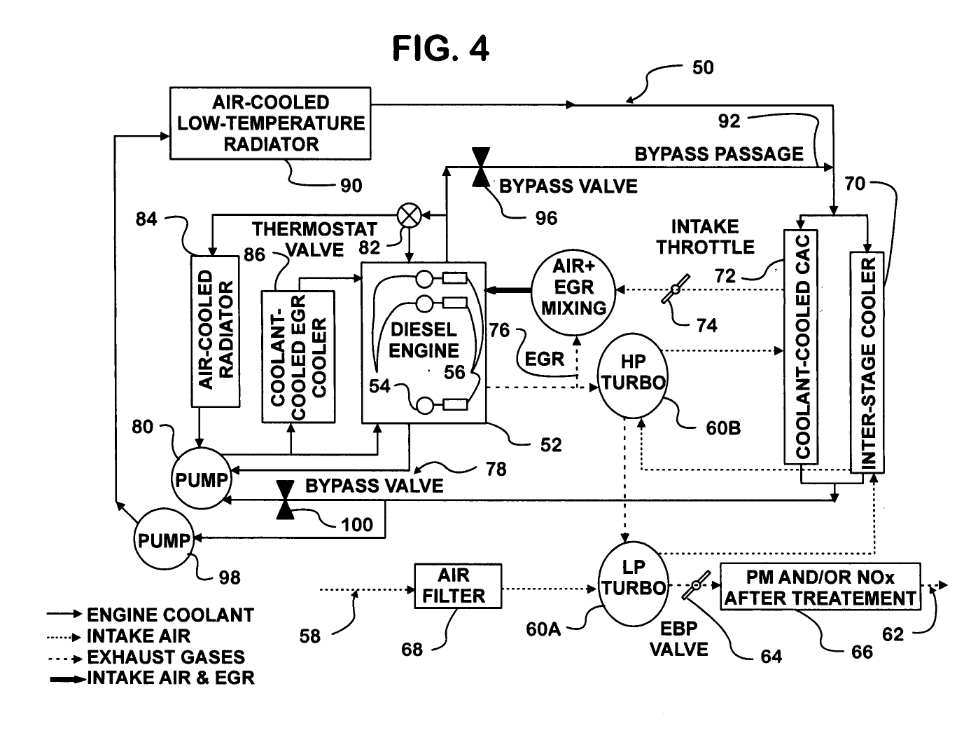

The embodiment of FIG. 4 is different from those of FIGS. 1A, 1B, 1C, 1D, 2, and 3 in several respects. First, it comprises an additional and separate non-engine-driven variable flow coolant pump 98, and while it comprises a valve 96 as in FIG. 3, it comprises no valve in the flow path from pump 98 to the inlets of coolers 70, 72, but rather comprises a control valve 100 in the return flow path from coolers 70, 72 to pump 80. The outlets of coolers 70, 72 have direct fluid communication with the inlet of pump 98.

Flow through air-cooled low-temperature radiator 90 is controlled entirely by pump 98 because the circuit from the pump outlet to the pump inlet contains no valve. A “hotter” coolant flow drawn from the engine outlet (i.e., near thermostat inlet) can flow through heat exchangers 70, 72 when both valves 96 and 100 are open and the pump 98 is shut off. The coolant flows through the coolant-cooled CAC.

In order to meet NOₓ emissions at high engine load, it is desirable to obtain low-temperature CAC coolant whose temperature is slightly higher than ambient air temperature. If the coolant flow in air-cooled low-temperature radiator 90 is drawn from the engine-driven coolant pump outlet instead of the engine outlet, the low-temperature radiator can be designed in a smaller size to save hardware cost.

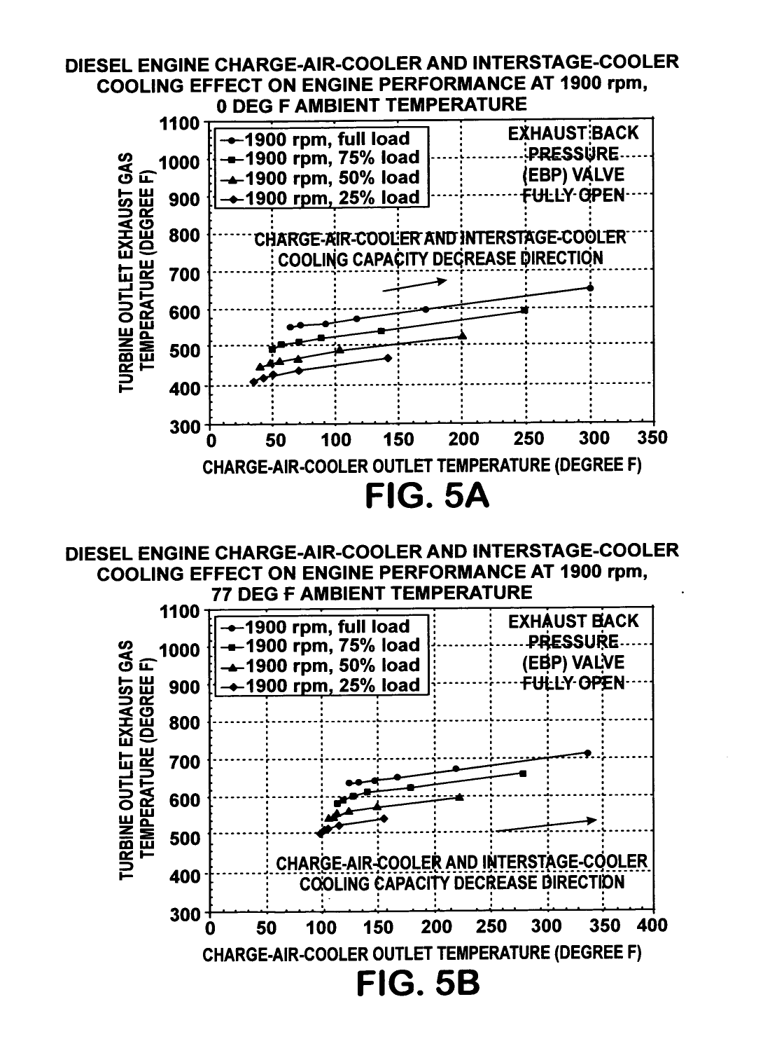

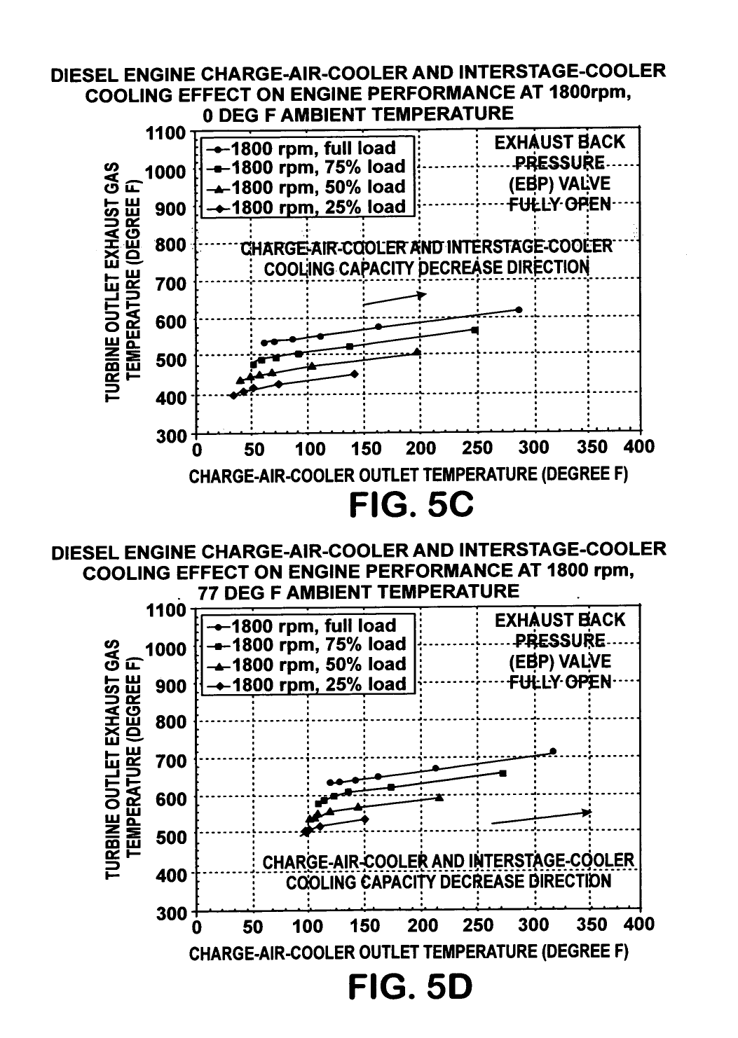

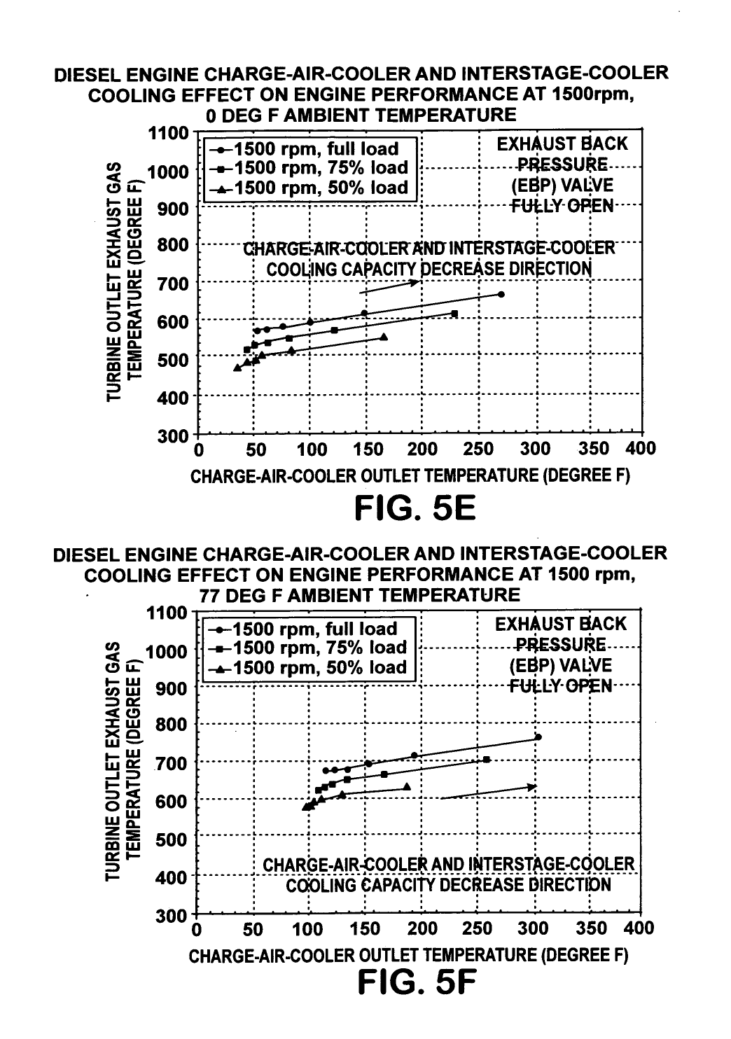

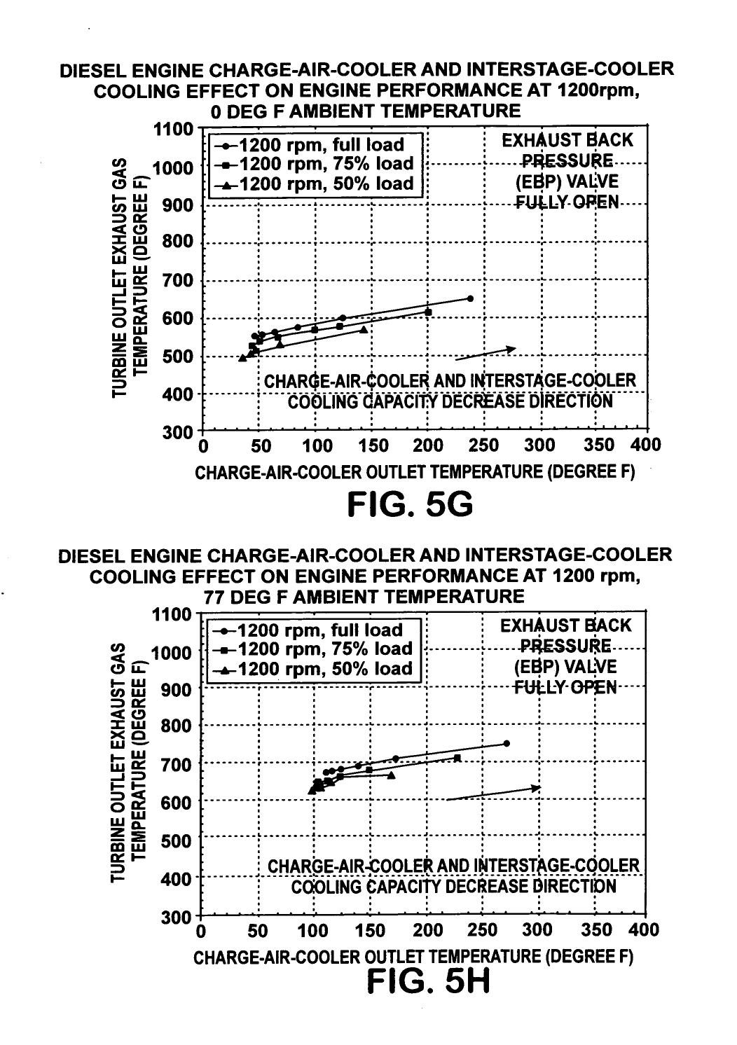

FIGS. 5A-5H are a series of graph plots showing that exhaust gas temperature increases, as CAC coolant flow rate is reduced. The top graph plot on each sheet, FIGS. 5A, 5C, 5E, and 5G are traces taken at 0° F. ambient, while the bottom graph plots are traces taken at 77° F. ambient.

The traces in FIGS. 5A and 5B are taken at 1900 rpm engine speed for loads of 25%, 50%, 75%, and full (100%) load. The traces in FIGS. 5C and 5D are taken at 1800 rpm engine speed for loads of 25%, 50%, 75%, and full (100%) load. The traces in FIGS. 5E and 5F are taken at 1500 rpm engine speed for loads of 50%, 75%, and full (100%) load. The traces in FIGS. 5G and 5H are taken at 1200 rpm engine speed for loads of 50%, 75%, and full (100%) load.

These series of traces show correlative relationships that confirm the capability of flexible coolant control to achieve various degrees of cooling. CAC coolant at cold ambient is colder than that at normal ambient. CAC outlet air temperature and exhaust gas temperature are also lower at cold ambient than those at normal ambient temperature.

In cold ambient at low engine load using hot CAC coolant can increase exhaust gas temperature.

In order to increase exhaust gas temperature at low engine load in cold ambient for after-treatment regeneration and/or performance, it is desirable to draw the “hotter” engine coolant from the engine outlet instead of the engine-driven coolant pump outlet, and flow it through the bypass passage to coolers 70, 72.

FIG. 1A and FIG. 2 reflect the trade-off between the demand on “colder” CAC coolant for high-load NOₓ emissions and the requirement on “hotter” CAC coolant for low-load high exhaust gas temperature for diesel after-treatment regeneration.

FIG. 3 avoids this trade-off by using two valves (a CAC control valve and a by-pass valve) and feeding two CAC coolant flows from different locations.

Each FIGS. 1A, 1B, 1C, 1D, 2, and 3 uses only one engine-driven coolant pump in the CAC cooling loop, with the pump being shared by the engine cooling loop, too. The coolant at the engine-driven pump outlet will be hot when the engine is running at operating temperature. In order to provide “colder” coolant temperature to CAC 72 and inter-stage cooler 70 at normal ambient temperature, radiator 90 must be quite large in those six embodiments. The FIG. 4 embodiment can achieve very cold CAC coolant by using the separate non-engine driven coolant pump 98 to exclusively serve the CAC cooling loop without mixing with hot engine coolant.

FIGS. 1A, 2, 3, and 4 sequentially achieve progressively improved engine and after-treatment regeneration performance with gradually increased hardware cost.

Shutting off CAC coolant flow or supplying hot engine coolant for charge air to CAC 72 (at low load) result in higher intake manifold temperature and consequently higher exhaust gas temperature. Higher intake manifold temperature could lead to higher NOₓ emission. Adjusting engine calibration parameters (such as retarding fuel injection timing, increasing EGR rate, reducing air-to-fuel ratio) may be used to avoid that possibility so that NOₓ emission standards may be met.

For DPF regeneration at low engine load, besides using hot engine coolant to increase exhaust gas temperature as described above, an EBP valve can be regulated at different speed and load to reduce air-to-fuel ratio in order to increase exhaust gas temperature or make the temperature more uniform in speed-load domain. For turbocharged engines, air-to-fuel ratio and exhaust gas temperature are very sensitive to exhaust restriction. Engine soot loading in DPF results in an increase on exhaust restriction. Closing the EBP valve can also increase exhaust restriction. If regeneration is needed, a target exhaust restriction can be achieved by regulating the EBP valve opening based on the DPF soot loading at that moment in order to light off the soot.

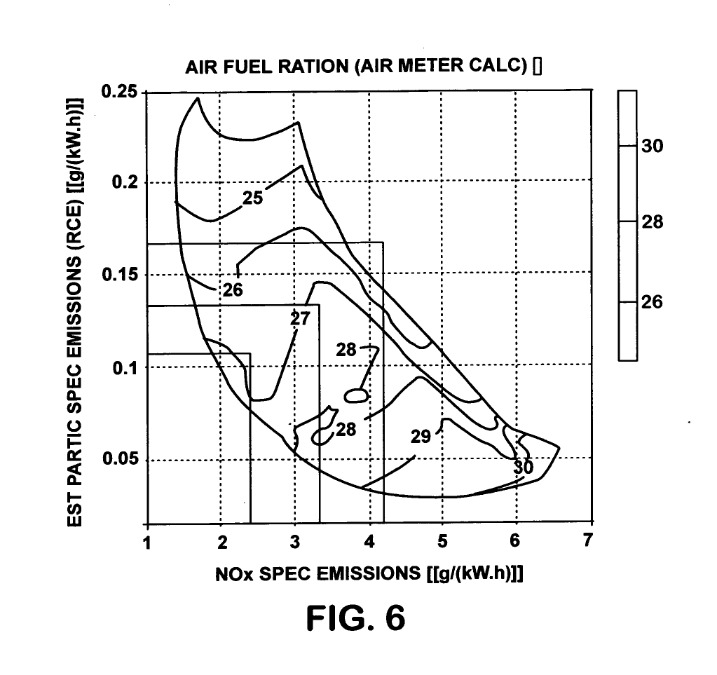

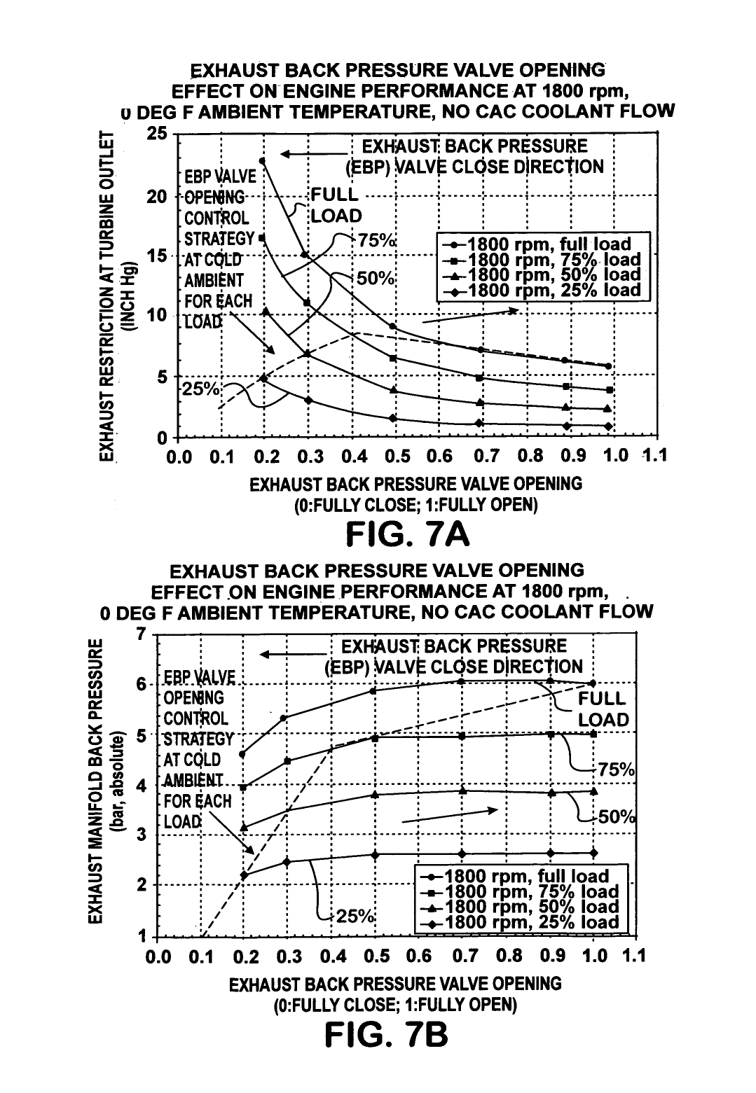

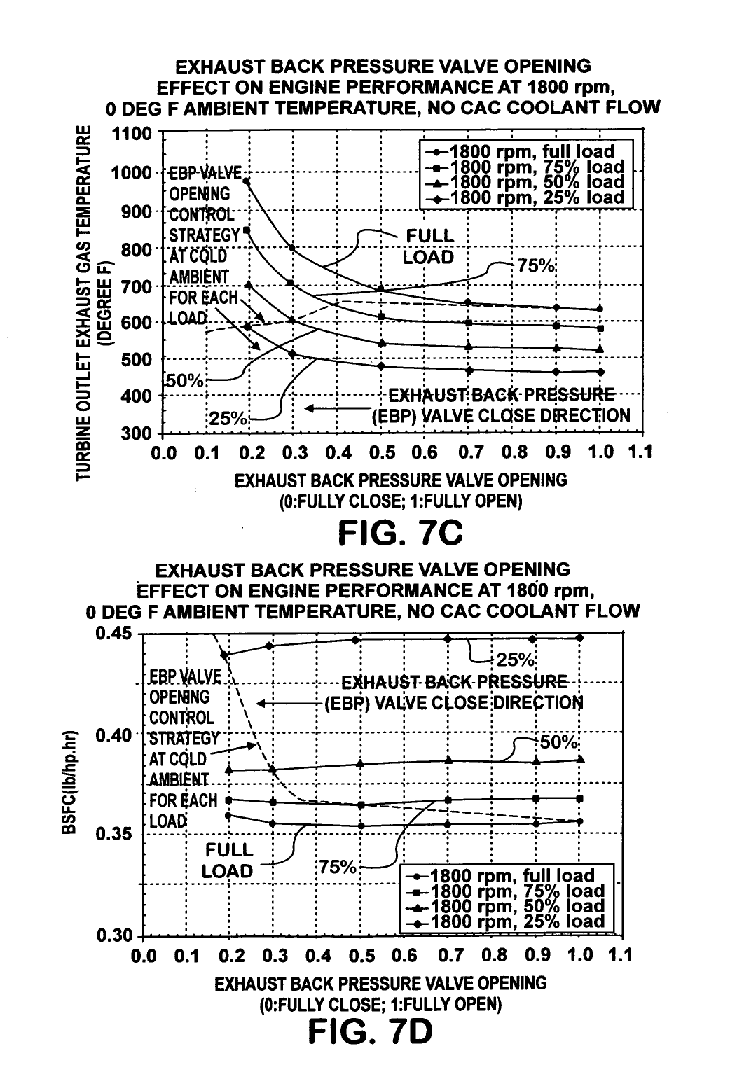

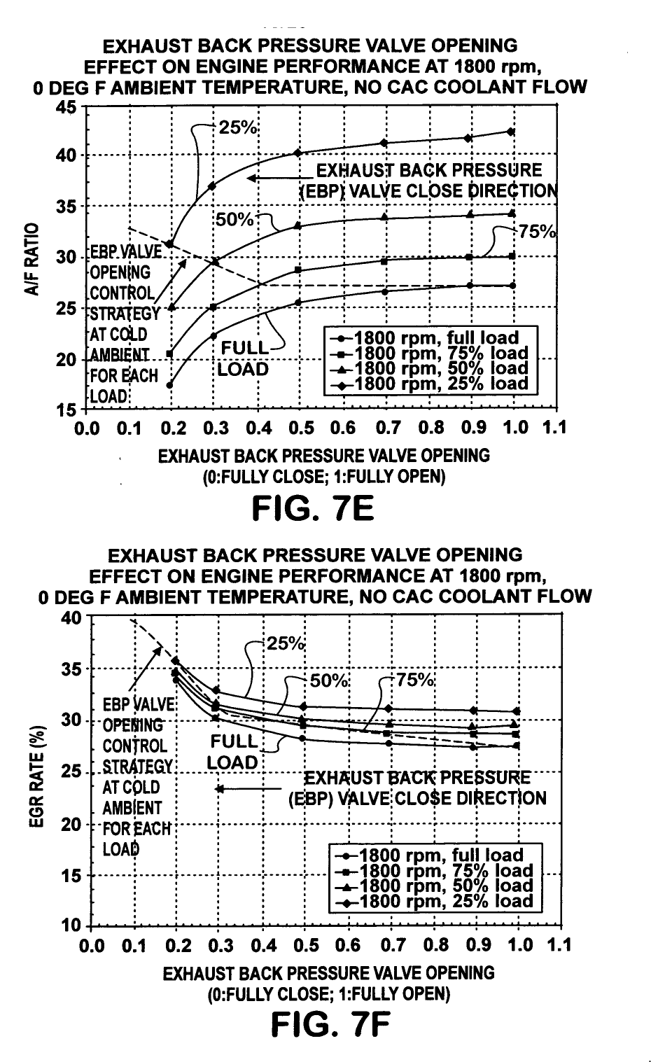

FIGS. 7A-7F show the control strategy of EBP valve opening or essentially exhaust restriction control at different engine loads in cold ambient for DPF regeneration. At full load, the EBP valve is fully open, and it is gradually closed as engine load decreases. When the EBP valve is closed, exhaust restriction increases and air-to-fuel ratio decreases. The FIGS. show the EBP valve opening at the beginning of DPF regeneration in order to light off the soot in the DPF. After lighting off or regeneration, the EBP valve opening is set to fully open again at any engine speed and load. The low air-to-fuel ratio (low oxygen concentration) in engine cylinders during the short period of DPF regeneration generally leads to low NOₓ emission (FIG. 6), although it also results in higher PM emission. Such PM emission can be removed by DPF regeneration or other engine calibration measures. If needed, intake throttle can also be used to reduce air-to-fuel ratio to help control NOₓ. Moreover, engine calibration parameters (such as fuel injection timing, fuel injection pressure, EGR rate) may be tuned to control NOₓ and PM emissions when EBP valve is regulated. FIG. 7 also shows that the penalty on brake specific fuel consumption (BSFC) with closing EBP valve is generally small at high engine load, and actually there is a reduction on BSFC at low load when air-to-fuel ratio is reduced. For achieving desired SCR efficiency at cold ambient temperatures, closing the EBP valve can increase exhaust gas temperature to assist the thermal management strategy.

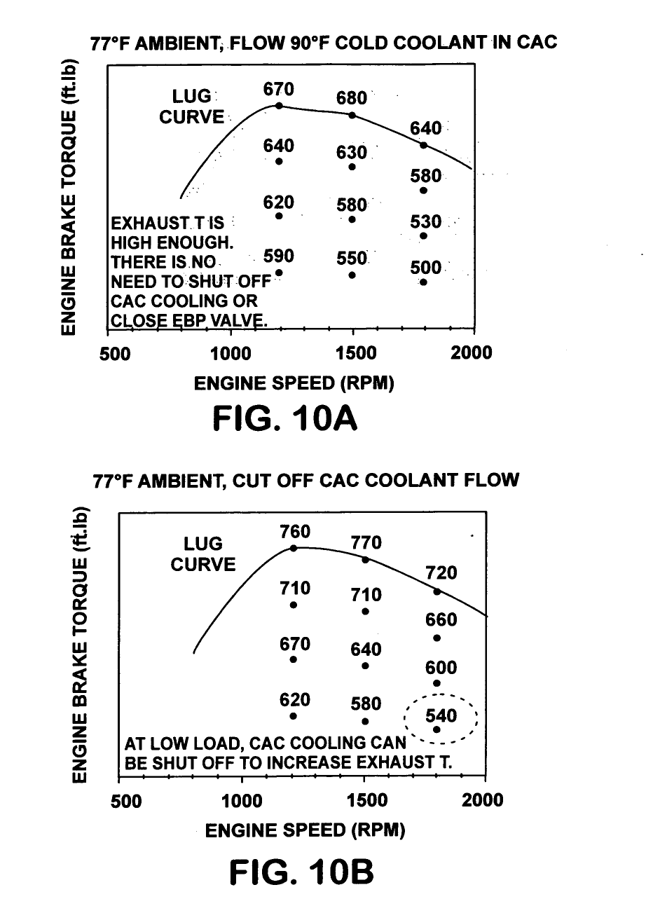

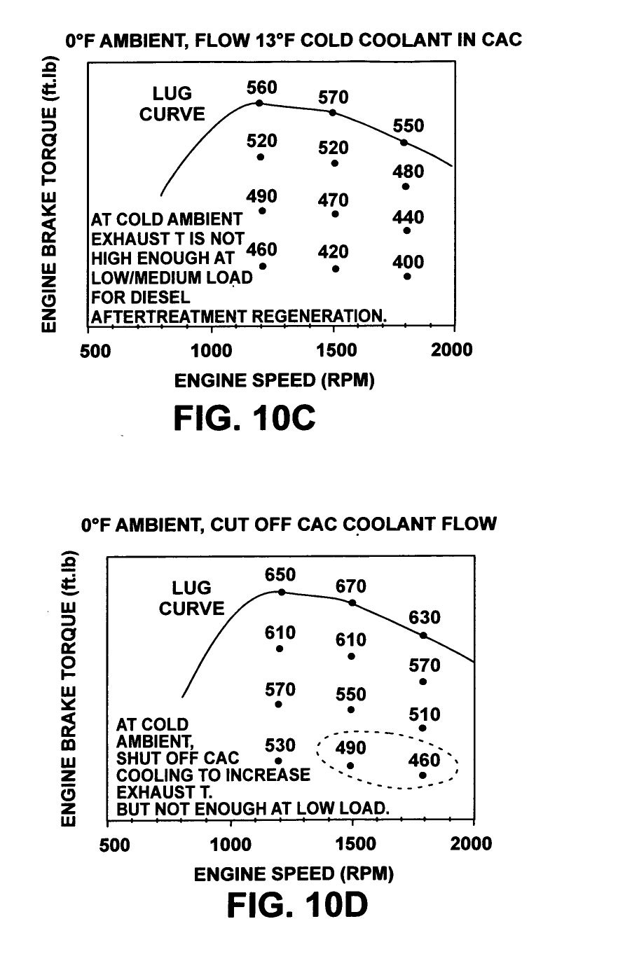

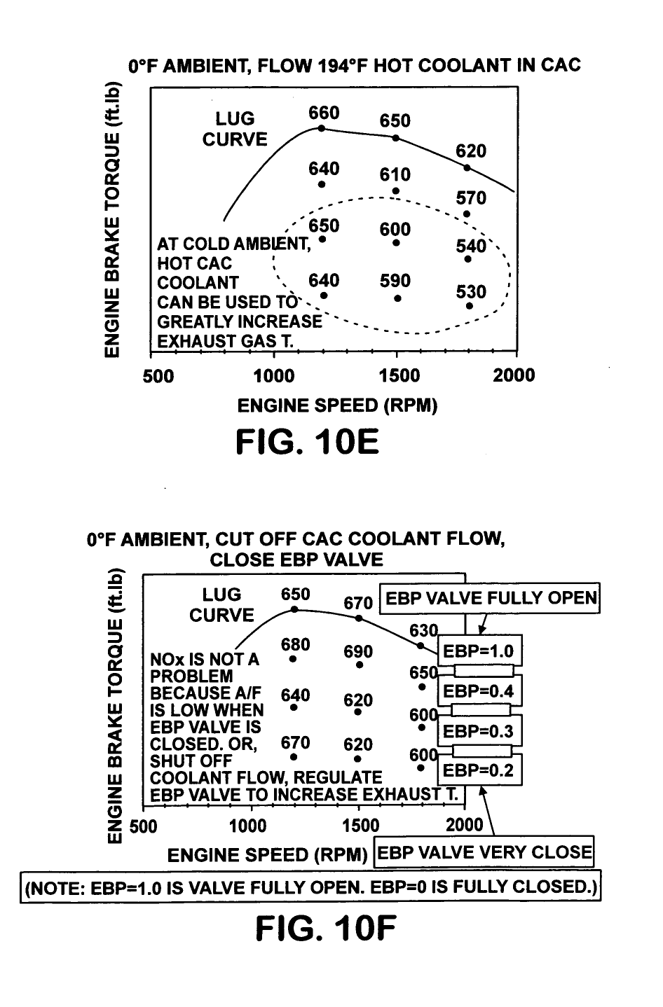

FIGS. 10A-10F show the control mechanisms of flexible CAC cooling and exhaust gas temperature controls for after-treatment regeneration.

At normal ambient (e.g. 77° F.), when cold CAC coolant (e.g. 90° F.) is used, turbine outlet exhaust gas temperature is sufficiently high to light off DPF (FIG. 10A). Generally there is no need to shut off CAC cooling or close the EBP valve unless there is a desire to further increase exhaust gas temperature at low engine load (FIG. 10B).

At cold ambient (e.g. 0° F.) and medium-to-high load, when cold CAC coolant (e.g. 13° F.) is used, turbine outlet exhaust gas temperature is not sufficiently high to light off DPF. (FIG. 10C) The CAC cooling is shut off to increase exhaust temperature at medium-to-high load. (FIG. 10D) At cold ambient (e.g. 0° F.) and low-to-medium load, when cold CAC coolant (e.g. 13° F.) is used, turbine outlet exhaust gas temperature is very low. Hot CAC coolant (e.g. 194° F.) is used to increase exhaust gas temperature to light off DPF at low-to-medium load in cold climates. (FIG. 10E) Hot CAC coolant can also be used during engine warm up. Another alternative way is to regulate the EBP valve at each speed and load to increase exhaust gas temperature to light off DPF or make the exhaust temperature more uniform in speed-load domain. (FIG. 10F) NOₓ emission is usually not a problem because air-to-fuel ratio is low when EBP valve is closed. Moreover, other engine calibration parameters (such as fuel injection timing, fuel injection pressure, EGR rate, intake throttle) can be tuned to control NOₓ and PM.

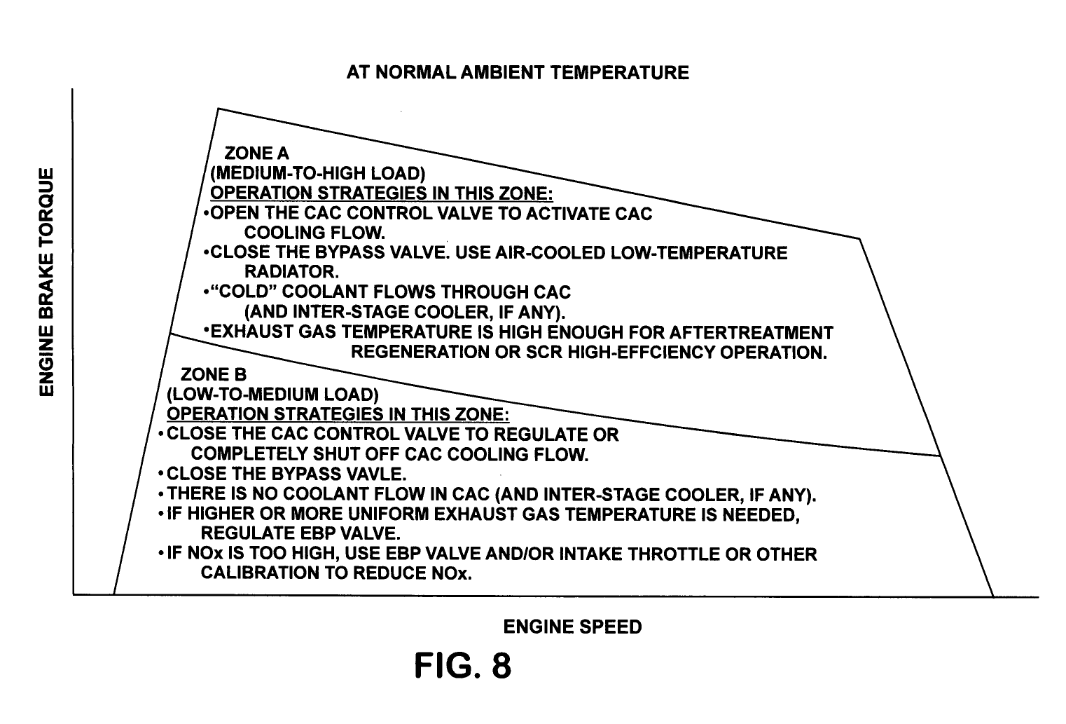

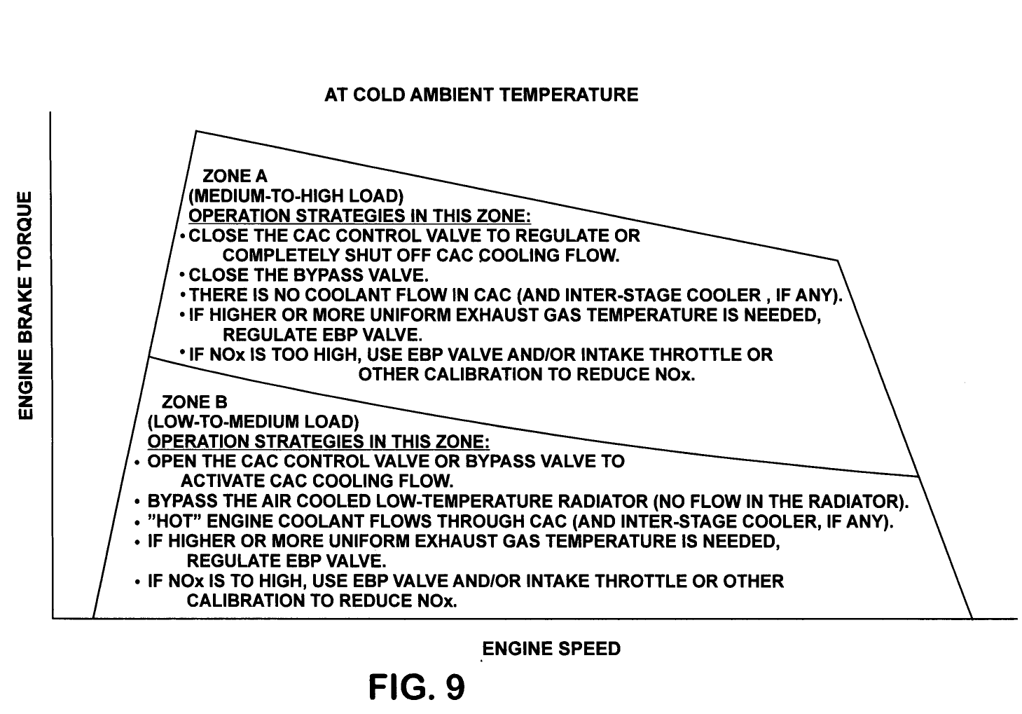

FIGS. 8 and 9 show the control strategies on flexible CAC cooling and exhaust gas temperature to meet both emissions standard and DPF regeneration requirements simultaneously at different engine speeds, loads and ambient conditions.

While a presently preferred embodiment of the invention has been illustrated and described, it should be appreciated that principles of the invention apply to all embodiments falling within the scope of the following claims.

What is claimed is:

1. An internal combustion engine comprising:
an intake system for creating charge air in an intake manifold;
combustion chambers in which charge air from the intake manifold and fuel are combusted;
an exhaust system for conveying exhaust gas from the combustion chambers through an exhaust gas treatment device that at times requires regeneration by elevation of exhaust gas temperature;
a charge air cooler comprising an airflow path for charge air upstream of the intake manifold and a liquid flow path for liquid engine coolant in heat exchange relationship with the airflow path;
a flow control system for controlling engine coolant flow through the liquid flow path of the charge air cooler; and
a control system comprising an executable strategy for conjunctive control of the flow control system and of the exhaust system to initiate regeneration of the exhaust gas treatment device.

2. An engine as set forth in claim 1 further comprising:
a control device for selectively restricting flow through the exhaust system upstream of the exhaust gas treatment device; and
wherein the control system comprising a strategy for conjunctive control of the flow control system and the control device to initiate regeneration of the exhaust gas treatment device strategy.

3. An engine as set forth in claim 2 further comprising:
at least one of an EGR system for recirculating exhaust gas from the exhaust system to the intake system, a fuel injection system for injecting fuel directly into the combustion chambers, and an intake throttle in the intake system for selectively restricting charge air into the combustion chambers; and
wherein the control system comprising a strategy for conjunctive control of the flow control system, of the control device, and the at least one of the EGR system, the fuel injection system, and the intake throttle to initiate regeneration of the exhaust gas treatment device strategy.

4. An engine as set forth in claim 1 wherein the exhaust gas treatment device comprises a diesel particulate filter.

5. An engine as set forth in claim 1 wherein the exhaust gas treatment device comprises a device for performing for selective catalytic reduction.

6. An engine as set forth in claim 1 wherein the strategy exercises conjunctive control as a function of ambient temperature.

7. An engine as set forth in claim 1 wherein the intake system comprises a two-stage turbocharger for creating the charge air and comprising an inter-stage heat exchanger, and wherein the inter-stage heat exchanger and liquid flow path of the charge air cooler are arranged in parallel flow relationship.

8. An engine as set forth in claim 1 wherein the flow control system comprises parallel flow paths each having fluid communication with the liquid flow path through the charge air cooler, and at least one valve for selectively apportioning flow through the parallel flow paths, one of the flow paths comprising a radiator at which coolant heated at the charge air cooler is rejected.

9. An engine as set forth in claim 8 wherein the at least one valve is selectively operable to a first condition that disallows flow through a first of the parallel flow paths while allowing flow through a second of the parallel flow paths, to a second condition that disallows flow through the second of the parallel flow paths while allowing flow through the first of the parallel flow paths, to a third condition that divides incoming flow between the first and second of the parallel flow paths, and to a fourth condition that blocks incoming flow from the parallel flow paths.

10. An engine as set forth in claim 9 wherein the at least one valve comprises a three-way valve that by itself is selectively operable to the first condition, to the second condition, to the third condition, and to the fourth condition.

11. An engine as set forth in claim 10 further comprising a main radiator at which waste heat from the engine is rejected when a thermostat valve allows engine coolant pumped by a coolant pump to flow out of an engine block containing the combustion chambers, through the main radiator, and back to the engine block, and the three-way valve has an inlet in fluid communication with an outlet of the main radiator, a first outlet in fluid communication with the first parallel flow path, and a second outlet in fluid communication with the second parallel flow path.

12. An engine as set forth in claim 10 further comprising a main radiator at which waste heat from the engine is rejected when a thermostat valve allows engine coolant pumped by a coolant pump to flow out of an engine block containing the combustion chambers, through the main radiator, and back to the engine block, and the three-way valve has an inlet in direct fluid communication with an outlet of the pump, a first outlet in fluid communication with the first parallel flow path, and a second outlet in fluid communication with the second parallel flow path.

13. An engine as set forth in claim 8 wherein the at least one valve comprises a first valve in series flow relationship with the first parallel flow path and a second valve in series flow relationship with the second parallel flow path.

14. An engine as set forth in claim 13 further comprising a main radiator at which waste heat from the engine is rejected when a thermostat valve allows engine coolant pumped by a coolant pump to flow out of an engine block containing the combustion chambers and through the main radiator to an outlet of the main radiator, the first valve has an inlet in direct fluid communication with an outlet of the pump and an outlet in fluid communication with the first parallel flow path, and the second valve has an inlet in fluid communication with the outlet of the main radiator and an outlet in fluid communication with the second parallel flow path.

15. An engine as set forth in claim 1 further comprising a main radiator at which waste heat from the engine is rejected when a thermostat valve allows engine coolant pumped by an engine-driven coolant pump to flow out of an engine block containing the combustion chambers, through the main radiator, and back to the engine block, and the flow control system comprises a first valve that has an inlet in direct fluid communication with an outlet of the pump and an outlet in fluid communication with the liquid flow path of the charge air cooler, and a coolant loop that includes an auxiliary radiator, a non-engine driven pump, and the liquid flow path of the charge air cooler.

16. An internal combustion engine comprising:
an intake system for creating charge air in an intake manifold;
combustion chambers in which charge air from the intake manifold and fuel are combusted;
a charge air cooler comprising a liquid flow path for liquid engine coolant to flow in heat exchange relationship with charge air flow through the charge air cooler; and
an engine coolant temperature and flow control system for controlling temperature and flow of engine coolant through the liquid flow path of the charge air cooler for selectively heating and cooling the charge air flowing through the charge air cooler.

17. An engine as set forth in claim 16 wherein the control system comprises parallel flow paths each having fluid communication with the liquid flow path through the charge air cooler, and at least one valve for selectively apportioning flow through the parallel flow paths, one of the flow paths comprising a radiator at which coolant heated at the charge air cooler is rejected.

18. An engine as set forth in claim 17 wherein the at least one valve is selectively operable to a first condition that disallows flow through a first of the parallel flow paths while allowing flow through a second of the parallel flow paths, to a second condition that disallows flow through the second of the parallel flow paths while allowing flow through the first of the parallel flow paths, to a third condition that divides incoming flow between the first and second of the parallel flow paths, and to a fourth condition that blocks incoming flow from the parallel flow paths.

19. An engine as set forth in claim 17 wherein the at least one valve comprises a three-way valve that by itself is selectively operable to the first condition, to the second condition, to the third condition, and to the fourth condition.

20. An engine as set forth in claim 19 further comprising a main radiator at which waste heat from the engine is rejected when a thermostat valve allows engine coolant pumped by a coolant pump to flow out of an engine block containing the combustion chambers, through the main radiator, and back to the engine block, and the three-way valve has an inlet in fluid communication with an outlet of the main radiator, a first outlet in fluid communication with the first parallel flow path, and a second outlet in fluid communication with the second parallel flow path.

21. An engine as set forth in claim 19 further comprising a main radiator at which waste heat from the engine when a thermostat valve allows engine coolant pumped by a coolant pump to flow out of an engine block containing the combustion chambers, through the main radiator, and back to the engine block, and the three-way valve has an inlet in direct fluid communication with an outlet of the pump, a first outlet in fluid communication with the first parallel flow path, and a second outlet in fluid communication with the second parallel flow path.

22. An engine as set forth in claim 17 wherein the at least one valve comprises a first valve in series flow relationship with the first parallel flow path and a second valve in series flow relationship with the second parallel flow path.

23. An engine as set forth in claim 22 further comprising a main radiator at which waste heat from the engine when a thermostat valve allows engine coolant pumped by a coolant pump to flow out of an engine block containing the combustion chambers and through the main radiator to an outlet of the main radiator, the first valve has an inlet in direct fluid communication with an outlet of the pump and an outlet in fluid communication with the first parallel flow path, and the second valve has an inlet in fluid communication with the outlet of the main radiator and an outlet in fluid communication with the second parallel flow path.

24. An engine as set forth in claim 22 further comprising a main radiator at which waste heat from the engine is rejected when a thermostat valve allows engine coolant pumped by an engine-driven coolant pump to flow out of an engine block containing the combustion chambers, through the main radiator, and back to the engine block, and the flow control system comprises a first valve that has an inlet in direct fluid communication with an outlet of the pump and an outlet in fluid communication with the heat exchanger, and a coolant loop that includes an auxiliary radiator, a non-engine driven pump, and the charge air cooler.

25. An engine as set forth in claim 16 wherein the engine comprises an engine block containing the combustion chambers and having internal coolant passages through which engine coolant flows to absorb some heat of combustion from the combustion chambers, and the control system comprises parallel branches for engine coolant flow, each branch having fluid communication with the liquid flow path through the charge air cooler, a first of the parallel branches comprising a radiator in upstream flow relation to the liquid flow path through the charge air cooler and a second of the parallel branches comprising a radiator-free flow path from the engine block to the liquid flow path through the charge air cooler for conveying coolant that has been heated by combustion in the block directly to the charge air cooler, and one or more valves for selectively controlling flows through the parallel branches.

26. An engine as set forth in claim 25 wherein the one or more valves are in downstream flow relationship to the radiator and the engine block.

27. An engine as set forth in claim 25 wherein the one or more valves comprise a first valve for controlling flow through the radiator and a second valve in the second parallel branch.

28. An engine as set forth in claim 27 wherein the first valve is in upstream flow relationship to the radiator.

29. An engine as set forth in claim 28 including a coolant pump for pumping coolant through the flow control system, the pump having an outlet that is in fluid communication with the first valve.

30. A method for controlling temperature of exhaust gas flow through an exhaust system of an internal combustion engine comprising an intake system for creating charge air and delivering the charge air to engine combustion chambers, a charge air cooler disposed in heat exchange relation with the charge air comprising a liquid flow path for liquid engine coolant to flow through the charge air cooler, a control system for controlling the exhaust system and engine coolant flow through the charge air cooler, the method comprising:
operating the control system to conjunctively control the exhaust system and coolant flow through the liquid flow path of the charge air cooler.

31. A method as set forth in claim 30 wherein the step of conjunctively controlling the exhaust system and coolant flow through the liquid flow path comprises conjunctively controlling exhaust back-pressure and coolant flow through the charge air cooler to create exhaust gas temperature high enough to initiate regeneration of an exhaust gas treatment device through which exhaust gas flows.

32. A method as set forth in claim 31 wherein the step of conjunctively controlling the exhaust system and coolant flow through the liquid flow path further includes controlling at least one of an EGR system for recirculating exhaust gas from the exhaust system to the intake system, a fuel injection system for injecting fuel directly into the combustion chambers, and an intake throttle in the intake system for selectively restricting charge air into the combustion chambers, in conjunction with controlling the exhaust back-pressure and coolant flow through the liquid flow path.

33. A method as set forth in claim 32 further including conjunctively controlling the exhaust system, coolant flow through the liquid flow path, and at least one of the EGR system, the fuel injection system, and the intake throttle as a function of ambient temperature.

34. A method for regulating charge air temperature in an intake manifold of an internal combustion engine comprising:
controlling the temperature of liquid engine coolant flowing through a liquid flow path of a charge air cooler that is in heat exchange relationship with charge air entering the intake manifold over a range that provides for the charge air to be selectively heated and cooled by liquid engine coolant.

35. A method as set forth in claim 34 wherein the temperature of the coolant flow through the liquid flow path is controlled by selectively apportioning flows from different portions of an engine cooling system.

36. A method as set forth in claim 35 wherein the step of selectively apportioning flows from different portions of the engine cooling system comprises selectively operating at least one valve selectively operable to a first condition that disallows flow through a first of parallel flow paths from different portions of the engine cooling system while allowing flow through a second of the parallel flow paths, to a second condition that disallows flow through the second of the parallel flow paths while allowing flow through the first of the parallel flow paths, to a third condition that divides incoming flow between the first and second of the parallel flow paths, and to a fourth condition that blocks incoming flow from the parallel flow paths.
